(19) United States
(12) Patent Application Publication
(10) Pub. No.: US 2005/0128296 A1
(43) Pub. Date: Jun. 16, 2005

(54) Processing systems and methods of controlling same

(76) Inventors: Vincent C. Skurdal, Boise, ID (US); Mark L. Brown, Boise, ID (US); Shane Gehring, Meridian, ID (US)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(21) Appl. No.: 10/735,120

(22) Filed: Dec. 11, 2003

(51) Int. Cl. H04N 7/18; H04N 5/228; G03B 13/00

(52) U.S. Cl. 348/154; 348/155; 348/208.1; 348/352

(57) ABSTRACT

The described embodiments relate to processing systems and means for controlling processing systems. One exemplary method includes sensing for a human presence in a region proximate a processing system independently of any human engagement of the processing system. The method further includes generating a signal based on the sensing; and, controlling at least one user-perceptible output of the processing system based, at least in part, on the signal.

### BACKGROUND

Processing systems such as the ubiquitous PC and home entertainment systems convert data into one or more human-perceptible outputs. Human-perceptible outputs can comprise a visual display and/or audible sounds among others. While processing systems come in many configurations a continuing need exists for controlling such processing systems to benefit a user.

### BRIEF DESCRIPTION OF THE DRAWINGS

The same numbers are used throughout the drawings to reference like features and components wherever feasible.

FIG. 1 is block diagram that illustrates various components of an exemplary processing system.

FIG. 2 illustrates an exemplary processing system in accordance with one embodiment.

FIG. 3 illustrates an exemplary processing system in accordance with one embodiment.

FIGS. 4a-4b illustrate an exemplary processing system in accordance with one embodiment.

FIGS. 5a-5b illustrate an exemplary processing system in accordance with one embodiment.

FIG. 6 illustrates an exemplary processing system in accordance with one embodiment.

FIG. 6a illustrates a remote control device in accordance with one embodiment.

FIG. 6b is block diagram that illustrates various components of an exemplary remote control device in accordance with one embodiment.

FIG. 7 illustrates an exemplary processing system in accordance with one embodiment.

### DETAILED DESCRIPTION

Overview

The following relates to processing systems which generate human perceptible outputs such as sound and/or visual images. A processing system can comprise a single device employing a processor, or multiple coupled devices at least one of which contains a processor. The processor(s) can process data and cause human perceptible output to be generated based on the processed data. Examples of processing systems can include a personal computer or PC and a home entertainment system, among others. Some of the described embodiments can control the processing system by sensing a presence or absence of a human proximate the processing system and controlling one or more functions of the processing system based on the sensing.

### Exemplary Embodiments

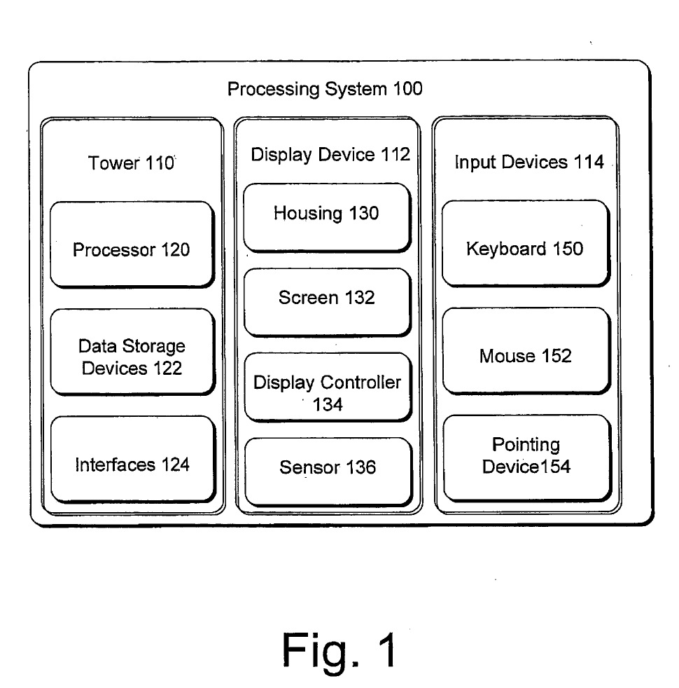

FIG. 1 illustrates various components of one exemplary processing system 100 comprising a base unit or tower 110, display device 112 and input devices 114. Tower 110 houses one or more processor(s) 120, data storage devices 122 and interfaces 124. Processor 120 processes various instructions to control the operation of processing system 100. The instructions can be stored on data storage device 122 which can comprise a digital versatile disk/compact disk (DVD/CD) drive, random access memory (RAM) and a hard disk among others.

Interfaces 124 provide a mechanism for various components of the processing system to communicate with other components of the processing system. In some embodiments interfaces 124 can allow processing device 100 to communicate with other devices and/or systems. Interfaces 124 can allow user input to be received by processor 120 from user input devices 114.

In this embodiment display device 112 comprises a monitor that includes a housing 130, a display means or screen 132, a display controller 134 and one or more sensors 136. Screen 132 can comprise an analog device such as a cathode ray tube or a digital device such as a liquid crystal display (LCD).

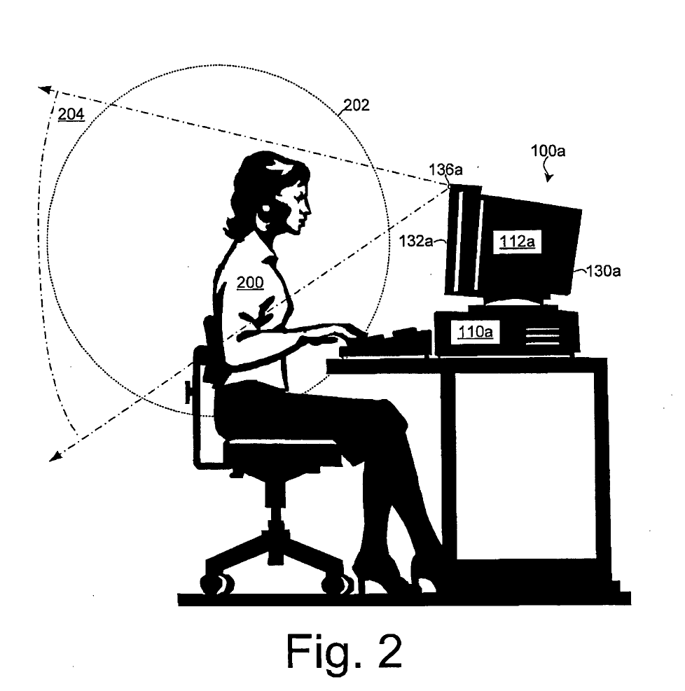

Display controller 134 can be implemented as hardware such as a processor in the form of a chip, software, firmware, or any combination thereof to process image data for display on screen 132. Display device 112 is configured to generate a visual display which can be viewable or discernable by a user in a user region proximate the display device as will be described in more detail below in relation to FIG. 2.

Sensor 136 can be mounted on housing 130 and is configured to detect the presence of a user in a sensed region proximate the processing system as will be described in more detail below. Sensor 136 can comprise any suitable type of sensor including, but not limited to, infrared (IR) sensors, sonar sensors, and motion sensors.

User input devices 114 may comprise among others, a keyboard 150, a mouse 152, a pointing device(s) 154, and/or other mechanisms to interact with, and to input information to processing system 100.

FIG. 2 illustrates a user, indicated generally at 200, sitting in user region 202 proximate processing system 100a. In this embodiment processing system 100a comprises a personal computer or “PC”. User region 202 includes a region from which images on screen 132a are viewable by the user. In this embodiment sensor 136a senses a condition of a sensed region 204 indicating a presence or absence of a user. Sensed region 204 includes at least a portion of user region 202. Sensor 136a can generate a status signal representing the sensed condition, i.e. a presence or absence of a user. The status signal can be utilized to control the performance of personal computer 100a among other uses.

While user 200 works at personal computer 100a, the status signal indicating the user's presence causes the personal computer to operate as would be expected of a personal computer. In such a circumstance personal computer 100a operates at a ‘standard operating mode’ with the tower's processor, shown in FIG. 1, running generally at its rated speed and user-perceptible images produced on display device 112a.

If user 200 stops working at personal computer 100a and leaves sensed region 204, sensor 136a can generate a different status signal indicating the user's absence. When the status signal indicates the user has left the sensed region, the personal computer's performance can be altered such as by changing from the standard operating mode. For example the personal computer can ‘power-down’ or go into a lower performance mode which uses less energy than the standard operating mode. Examples of such lower performance modes can include ‘stand-by’ and ‘hibernate’ among others.

In another example the processor of tower 110a can be maintained at a normal processing speed while display device 112a is turned off or otherwise affected such as by blanking screen 132a. Blanking screen 132a can result in significantly decreased energy consumption compared to a screen generating a viewable image. Further, blanking screen 132a can increase the life span of the display device 112a when compared to leaving screen 132a in a standard operating mode.

Some embodiments may incorporate a predetermined time delay when the status signal indicates that user 200 has left the sensed area before initiating any powering down of the personal computer. For example a time delay can maintain the personal computer in standard operating mode for a brief period of time such as when the user leaves the sensed area to retrieve a document from a printer associated with the personal computer. Various other embodiments also may have a scaled response when the user leaves the sensed area. For example, after one minute the screen can be dimmed and after ten minutes the personal computer can go into stand-by mode and after an hour the personal computer can go into hibernate mode.

Some embodiments may allow the user to adjust the relative position and/or size of sensed region 204. For example a particular user such as a file clerk may position an exemplary personal computer on a desk in an office which also contains file cabinets and a copy machine. This particular user frequently moves among the personal computer, the file cabinets, and the copier contained in the office. Some embodiments may allow the user to select a sensed region which is large enough to include a portion of the office where the file cabinets and copier are located in addition to the region from which the screen is viewable. In another example a user having a cubicle rather than an office may want to be able to sense a smaller region to avoid neighboring workers and/or passersby from being sensed.

In some embodiments a user can select what personal computer performance measures are taken and at what time intervals based upon the status signal. Such embodiments can utilize control panel selections or some other suitable configuration to allow user selection.

If the user approaches personal computer 100a when it is in a powered-down mode, the user is sensed in sensed region 204 and the personal computer can be powered-up based on the status signal. This powering-up can be caused by the status signal indicating the presence of the user and without any affirmative action on the part of the user. Such a configuration can begin powering-up the personal computer 100a before the user physically reaches the personal computer and without the user physically engaging the personal computer. A time differential between the user entering the sensed region and physically engaging the personal computer 100a can decrease or eliminate any lag time associated with the powering-up process where the user has to wait on the personal computer to be ready for use.

Some of the present embodiments can decrease or eliminate delays experienced by users wishing to utilize a powered-down personal computer. In addition to decreasing or eliminating delays caused by powering-up the personal computer, some of the present embodiments can allow the user to utilize the personal computer without physically engaging it. For example a user may leave his personal computer to attend a meeting. The user may want to check his email for an important message that he is expecting before attending a subsequent meeting, but may have his hands full of documents. With some of the present embodiments the personal computer senses the user's presence and powers up so he can see the image on his screen without ever physically engaging the personal computer. In this instance if the user left his computer with his inbox on the screen, the inbox image may reappear without any physical engagement of the personal computer.

As illustrated in FIG. 2, sensor 136a is positioned on display device 112a. More specifically sensor 136a is located above screen 132a and generally is pointing toward user region 202 from which an image on screen 132a can be viewed by a user. In this embodiment sensor 136a is supported by housing 130a and is fixed relative to screen 132a. Positioning the sensor relative to the screen ensures that the sensed area 204 comprises at least a portion of the user area 202. For example if a user reorients screen 132a to reduce glare from an office window, sensed region 204 is also reoriented and maintains its overlapping relationship with the user region.

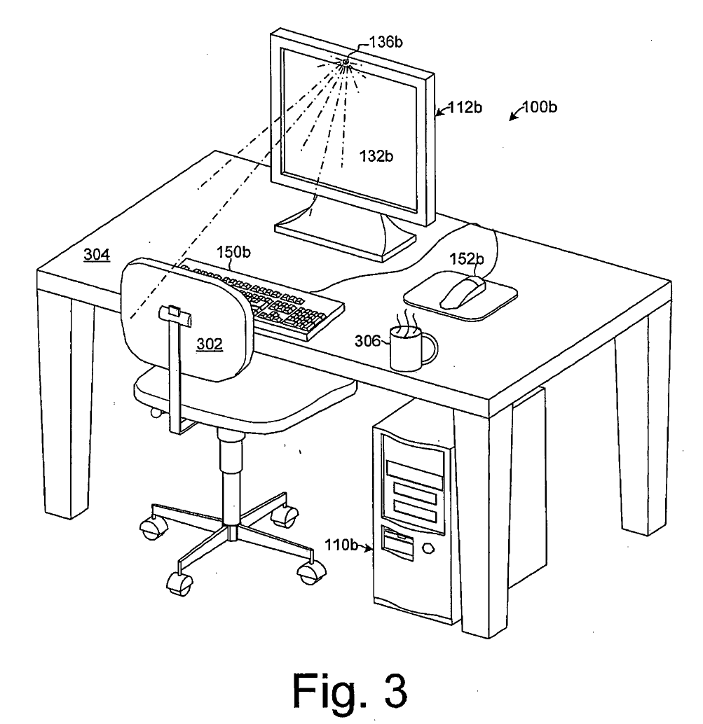

FIG. 3 shows another exemplary processing system 100b comprising a personal computer. In this instance the personal computer 100b is in a powered down mode and is sensing for a user presence. In this embodiment personal computer 100b comprises tower 110b, display device 112b, cordless keyboard 150b and cordless mouse 152b. A chair 302 is pushed against desk 304 which is supporting monitor 112b, keyboard 150b, mouse 152b, and a coffee cup 306. Sensor 136b is positioned above screen 132b and is oriented to sense a user in the sensed region a portion of which is indicated by dashed lines emanating from sensor 136b. Sensor 136b is positioned on an upper portion of display device 112b, at least in part, to decrease a likelihood of sensor 136b inadvertently being blocked by an obstruction that would interfere with proper functioning. For example, if a user approaches from behind chair 302, sensor 136b advantageously has an obstructed path; thus sensing the user.

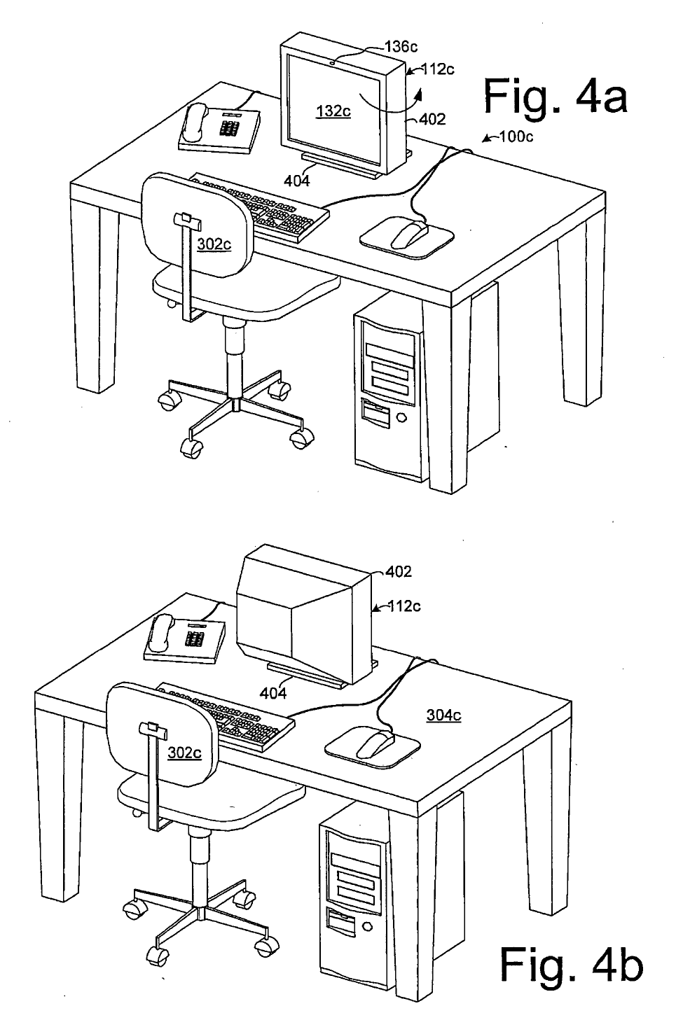

FIGS. 4a-4b show another exemplary processing system 100c comprising a personal computer. Display device 112c has a display portion 402 containing screen 132c and a base portion 404. In this embodiment sensor 136c is positioned on display device 112c to sense a sensed region which generally corresponds to a user region from which images on screen 132c are discernable by a user. In FIG. 4a the user region and the sensed region extend generally from screen 132c toward and beyond chair 302c.

In this embodiment the sensed region continues to overlap the user region even if display portion 402 is rotated as seen in FIG. 4b. For example, a user comprising an attorney may want to rotate display portion 402 as he walks around to a side of the desk 304c opposite the chair 302c so that he can review a document on screen 132c with a client. As the attorney and the client review the document, sensor 136c will sense their presence and will maintain the standard operating mode of the personal computer 100c.

The embodiments described above relate to processing systems. Other embodiments may comprise one or more devices comprising components of processing systems. For example a display device such as display device 112c configured with one or more sensors 136c may be utilized with an existing personal computer. The display device may be configured so that the visual output of the display device is controlled at least in part by the sensed signal. For example a consumer may purchase an exemplary display device configured to be coupled to a personal computer. Visual images created by the display device can be controlled at least in part by a sensed condition as described above. In some embodiments the display device may be configured to communicate the sensed condition to other components comprising the personal computer. In other embodiments the display device 112c may be configured so that the sensed condition only affects the display device and is not readily available to the other components.

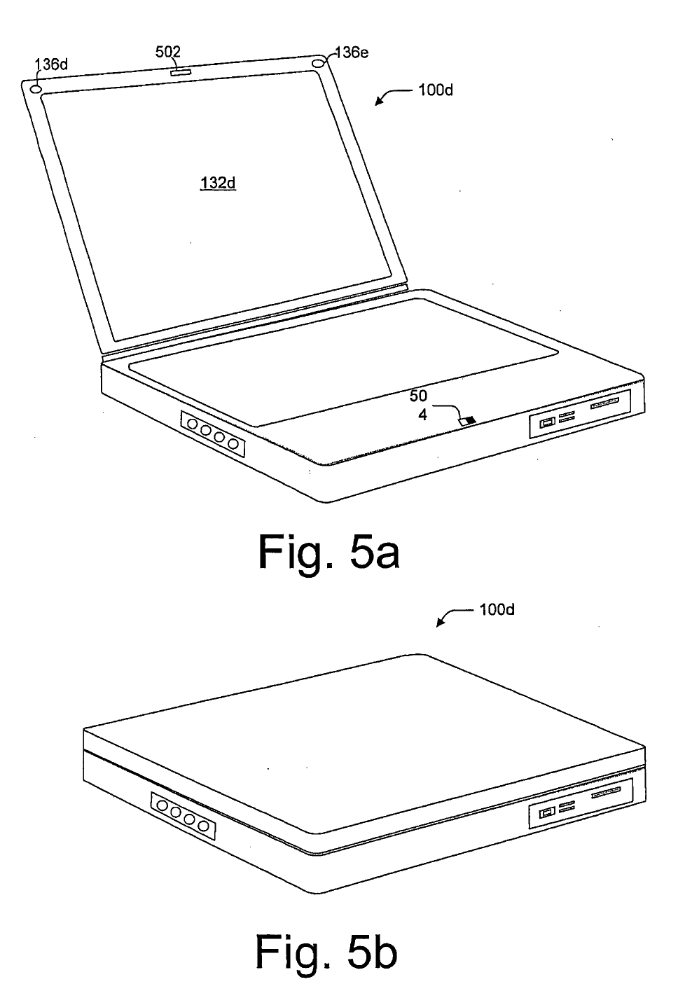

FIGS. 5a-5b illustrate another exemplary processing system 100d comprising a notebook computer. The embodiments described above illustrate processing devices having separate distinct components such as a display device and a tower. In this embodiment these components are integral in the notebook computer. FIG. 5a illustrates notebook computer 100d in an open or user position and FIG. 5b illustrates the notebook computer in a closed or storage position. In the open position, as illustrated in FIG. 5a, a pair of sensors 136d, 136e located at opposing corners of screen 132d can sense for a user presence.

In this particular embodiment when the notebook computer is closed as shown in FIG. 5b, sensors 136d, 136e are automatically turned-off. This can be accomplished in any suitable way. For example the sensors can be turned off when latch 502 engages receptacle 504. When notebook computer 100d is once again opened sensors 136d, 136e can be turned back on to function as described above.

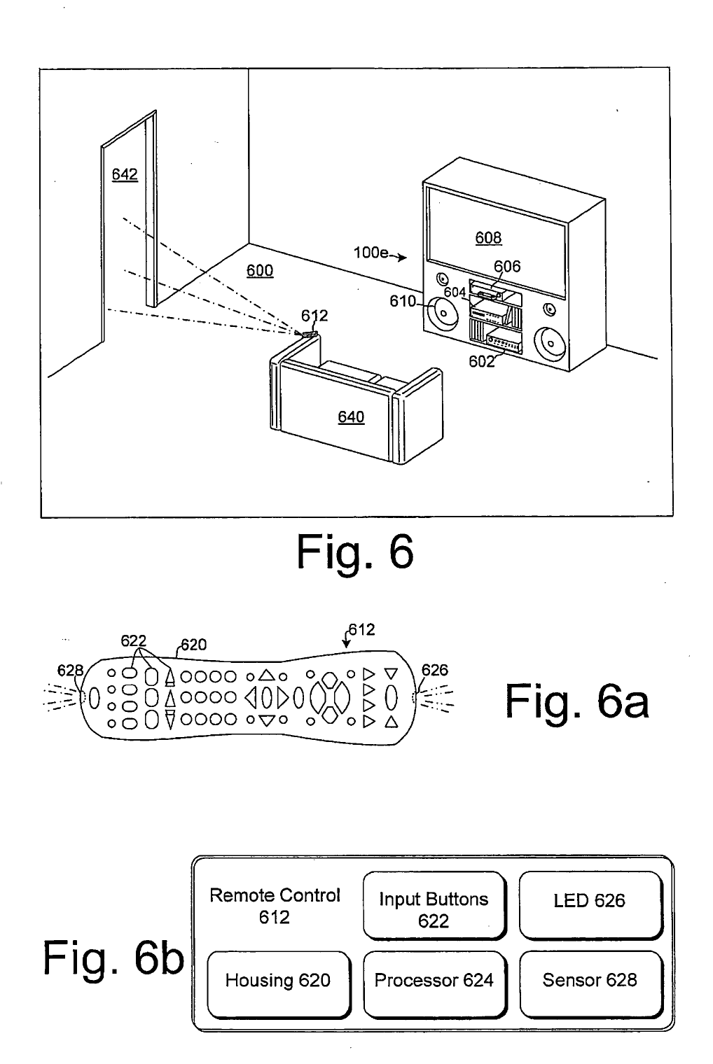

FIG. 6 illustrates another exemplary processing system 100e. In this embodiment processing system 100e comprises a home entertainment system positioned in a room 600 of a home such as a family room. The processing system comprises a receiver 602, a DVD player 604, a video cassette recorder (VCR) 606, a television (TV) 608, speakers 610, and a remote control 612. In this particular embodiment receiver 602, DVD player 604, VCR 606, television (TV) 608, and remote control 612 each contain a processor for performing at least a portion of their functionality. The home entertainment system creates human perceptible output in the form of visual images on TV 608 and sounds from speakers 610.

The receiver, DVD player, VCR and television are electrically coupled via electrically conductive wires. Remote control 612 is communicably coupled to the other components via a sending unit in the remote control and receiving units in one or more of the other components. In this particular instance remote control 612 is a ‘universal remote’ configured to control each of receiver 602, DVD player 604, VCR 606, television 608, and sound output from speakers 610 via receiver 602. Other embodiments may utilize a remote control which is communicably coupled with less than all of the other components. For example some embodiments may utilize a remote control 612 which is only configured to control television 608.

FIGS. 6a-6b show an enlarged view of remote control 612 and a block diagram of components of remote control 612 respectively. Remote control 612 comprises a housing 620 which supports user input buttons 622, a chip or processor 624, an LED or sending unit 626, and a sensor 628. User input buttons 622 create user-input signals when pressed by a user. The user-input signals are received by the chip 624. The chip can convert the user-input signals into a corresponding command signal that the chip causes to be emitted from the LED. The command signal can cause a selected component to perform a selected task. For example a user can push an input button labeled “play DVD”. Processor 624 receives a corresponding user input signal and causes a command signal to be generated by LED 626 that is detectable by DVD player 604 and causes the DVD player to begin playing a DVD.

Sensor 628 is configured to sense for a human presence in a region proximate the remote. The sensor can comprise any suitable type of sensor configurable to generate a sensed signal corresponding to the human presence or absence. Processor 624 can control one or more components of computing system 100e based, at least in part, on the sensed signal. For example processor 624 can control the visual output from TV 608 and/or the audio output from speakers 610 based on the sensed signal.

As illustrated in FIG. 6, one or more users (not shown) can sit on couch 640. In one example the users comprise parents who utilize remote control 612 to play a movie on DVD player 604. The movie is displayed as images on TV 608 and is audible via speakers 610. In this example the parents may have concerns about some of the content of the movie being inappropriate for their young children who are sleeping in another room of the house. After starting the movie, one of the parents can place remote control 612 on the couch arm or other suitable location with sensor 628 generally oriented toward a region to be sensed and LED 626 generally oriented toward the home entertainment system 100e. In this example the region to be sensed comprises doorway 642.

Once remote control 612 is oriented as desired a specific user input button 622 can be pushed to activate sensor 628. If one of the children approaches doorway 642, the sensor can generate a sensed signal indicating a human presence. The sensed signal can cause the remote control's processor 624 to generate a control signal that affects the visual and/or audio output of home entertainment system 100e. For example the processor can cause a stop DVD control signal to be generated which can cause the DVD player to stop playing the DVD and return to a menu display. In another example processor 624 may generate a control signal which causes TV 608 to turn to a channel on which no signal is being received. In still another example the control signal may turn off the TV and may mute the audio output.

Many existing remote controls contain suitable control commands that can be utilized in suitable embodiments. The skilled artisan should recognize how to couple sensor 628 to processor 624 to cause such command signals to be generated based on the sensed signal.

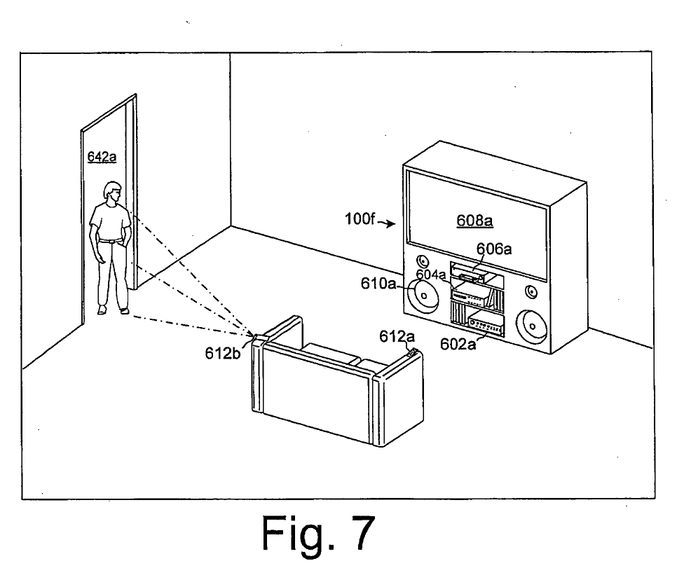

FIG. 7 shows another suitable embodiment which utilizes two or more remote controls to control entertainment system 100f. In this embodiment a first remote control 612a performs traditional functions to allow a user to control the entertainment system. A second remote control 612b is configured to generate a first or sensed signal relating to the presence or absence of a user in a region proximate the remote. As a result of the first signal, second remote control 612b also can generate a second or control signal configured to control a human-perceptible output of entertainment system 100f.

A user can orient second remote control 612b to sense a desired area such as doorway 642a and to transmit a control signal to entertainment system 100f. Second remote control 612b may comprise various suitable configurations. In one embodiment second remote control may have a single user input button to control an on/off state. For example second remote control may be configured during assembly to turn off TV 608a if a human is sensed in the sensed area. Other suitable embodiments may have multiple user input buttons or other means for allowing a user to select the commands desired when a human is sensed. Some such embodiments also may allow second remote control 612b to ‘learn’ how to control various devices comprising a processing system 100f. In one such embodiment a user may be able to select ‘turn off TV’ and ‘mute audio output’. The remote control can then cause the proper commands to be generated if a sensed signal indicates a human presence.

Though the embodiments relating to FIG. 7 are described in the context where a processing system 100f comprises a home entertainment system, these embodiments are equally applicable to other applications. For example a processing system in the form of a personal computer may be utilized to make a presentation such as a board room presentation. Confidential material may be displayed on or by a display device such as a projector. Remote control 612b can be utilized to automatically control the user-perceptible output of the personal computer when an unauthorized person such as a food server enters the board room. The skilled artisan should recognize other suitable embodiments.

### CONCLUSION

Processing systems and means for controlling processing systems are described. Some of the embodiments can sense a region proximate the processing system for a human presence or absence. A signal can be generated for controlling the processing system based at least in part on the sensed human presence or absence. Controlling can comprise in some embodiments altering a human-perceptible output of the processing system.

Although the inventive concepts have been described in language specific to structural features and/or methodological steps, it is to be understood that the inventive concepts in the appended claims are not limited to the specific features or steps described. Rather, the specific features and steps are disclosed as forms of implementing the inventive concepts.

1. A method comprising:
sensing for a human presence in a region proximate a processing system independently of any human engagement of the processing system;
generating a signal based on said sensing; and,
controlling at least one user-perceptible output of the processing system based, at least in part, on said signal.

2. The method as recited in claim 1, wherein said act of sensing comprises sensing the region from which a user can view a visual output of the processing system.

3. The method as recited in claim 1, wherein said act of controlling comprises muting an audio output associated with the processing system when the human presence is detected.

4. The method as recited in claim 1, wherein said act of controlling comprises blanking a display device associated with the processing system when the human presence is detected.

5. The method as recited in claim 1, wherein said act of controlling comprises blanking a display device associated with the processing system when the human presence is not detected.

6. The method as recited in claim 1, wherein said act of controlling comprises blanking a display device associated with the processing system if the human presence is not detected for a period of time.

7. The method as recited in claim 1, wherein said act of controlling comprises powering-up at least a portion of the processing system when a user is detected after a period when no user had been detected.

8. A method comprising:
defining a region proximate a processing system and within which a user enters to use the processing system;
detecting a user who has entered the region; and,
responsive to said detecting and independent of a user physically engaging the processing system, causing an effect on a display device associated with the processing system.

9. The method as recited in claim 8, wherein said defining comprises defining the region from which a visual image created by the processing system can be viewed by the user.

10. The method as recited in claim 8, wherein said causing comprises powering-up the display device when the user is detected.

11. The method as recited in claim 8, wherein said causing comprises powering-up the display device from a stand-by mode to an active mode when the user is detected.

12. The method as recited in claim 8, wherein said causing comprises powering-up at least a portion of the processing system when the user is detected.

13. The method as recited in claim 8, wherein said causing comprises powering-down the display device when the user is not detected.

14. The method as recited in claim 8, wherein said causing comprises powering-down the display device when the user is not detected for a predetermined period of time.

15. A display device comprising:
a means for creating a user-perceptible image which is viewable from a region proximate the display device;
a means for generating a signal relating to a user being present in the region; and,
a means for affecting the user-perceptible image based, at least in part, on the signal.

16. The display device as recited in claim 15, wherein the means for affecting comprises a means for processing which is positioned in the display device.

17. The display device as recited in claim 15, wherein the means for affecting comprises a means for processing which is positioned in a means for remotely controlling the display device.

18. The display device as recited in claim 15, wherein the means for generating a signal comprises a sensor.

19. The display device as recited in claim 15, wherein the means for creating a user-perceptible image comprises a digital device.

20. The display device as recited in claim 15, wherein the means for creating a user-perceptible image comprises a liquid crystal display.

21. The display device as recited in claim 15, wherein the means for creating a user-perceptible image comprises an analog device.

22. The display device as recited in claim 15, wherein the means for creating a user-perceptible image comprises a cathode ray tube.

23. A control device comprising:
a means for generating a sensing signal for determining a presence of a human in a region; and,
a means for generating a control signal for controlling a user-perceptible output of a processing system based, at least in part, on the sensing signal.

24. A control device as recited in claim 23 further comprising a means for allowing a user to control one or more processing devices of the processing system.

25. A control device comprising:
a sensor configured to generate a first signal relating to a human presence in a region proximate the sensor; and,
a controller configured to cause a second signal to be generated to control a user-perceptible output of a processing system based at least in part on the first signal.

26. The control device as recited in claim 25, wherein the control device comprises a remote control device.

27. The control device as recited in claim 25, wherein the sensor is configured to detect movement.

28. The control device as recited in claim 25, wherein the sensor is configured to detect a change between a first set of sensed data and a second subsequent set of sensed data.

29. The control device as recited in claim 25, wherein the control device is further manipulatable by a user to control one or more processing devices of the processing system.

30. A processing system comprising:
a display device comprising a first processor and configured to generate a visual display perceptible by a user positioned in a region proximate the display device; and,
at least one sensor coupled to the display device and configured to sense a human presence in the region independent of the human physically engaging the processing system, wherein the at least one sensor is configured to create a signal and wherein the visual display of the display device can be affected by the signal.

31. The processing system as recited in claim 30, wherein the at least one sensor is located on the display device generally above the visual display.

32. The processing system as recited in claim 30 further comprising a second device coupled to the display device and wherein the second device contains a second processor and wherein a processing speed of the second processor can be affected by the signal.

33. The processing system as recited in claim 32, wherein the second device comprises a tower.

34. The processing system as recited in claim 32 comprising a personal computer.

35. A processing system comprising:
a means for generating a visual image; and,
at least one means for sensing coupled to the means for generating and configured to sense a human presence in a region, wherein the means for sensing is configured to generate a signal relating to the human presence and wherein the visual image can be affected by the signal.

36. The processing system as recited in claim 35, wherein the means for sensing is positioned on the means for generating a visual image.

37. The processing system as recited in claim 35 further comprising a means for remotely controlling the means for generating a visual image and wherein the means for sensing is positioned on the means for remotely controlling.
